(19) United States
(12) Patent Application Publication
(10) Pub. No.: US 2009/0140663 A1
(43) Pub. Date: Jun. 4, 2009

(54) DISPLAY SYSTEM CAPABLE OF AUTO-ADJUSTING BRIGHTNESS AND METHOD FOR AUTO-ADJUSTING BRIGHTNESS THEREOF

(75) Inventor: JIN-LIN JIANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/131,046

(22) Filed: May 31, 2008

(30) Foreign Application Priority Data
Dec. 4, 2007 (CN) 200710202838.9

(51) Int. Cl. H05B 41/36; H02J 7/04

(52) U.S. Cl. 315/291; 320/101

(57) ABSTRACT

A display system includes a display panel, a solar battery, an electric current measuring module, a memory, and a brightness adjusting module. The solar battery is for converting light energy into electric current. The electric current measuring module is for measuring electric current generated from the solar battery. The memory is for storing a pre-defined associative array of current values and their corresponding brightness values. The brightness adjusting module is for querying the associative array stored in the memory to get the corresponding brightness value, using the measured electric current value as a key, and adjusting the brightness of the display based on the brightness value returned from the associative array.

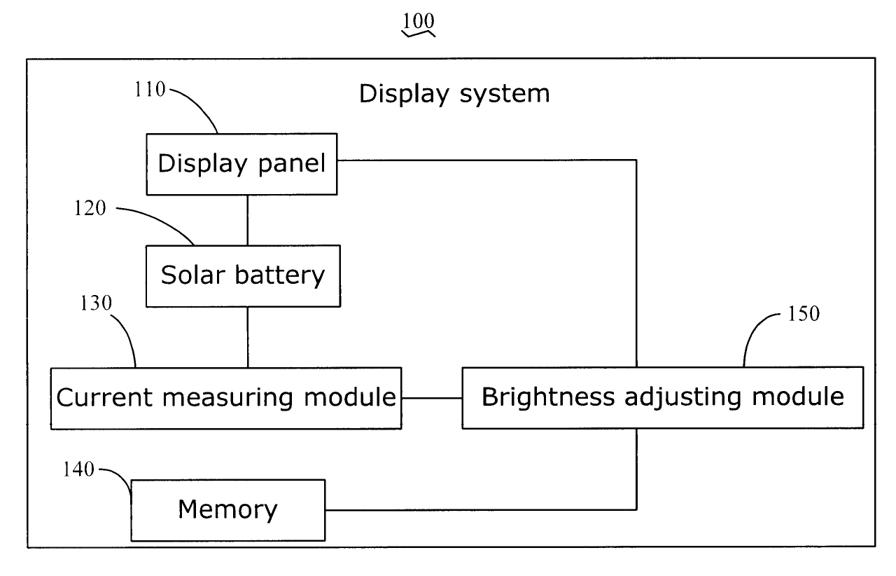

### BACKGROUND

1. Technical Field

The present invention relates to display systems, and particularly to a display system capable of auto-adjusting brightness and a method for auto-adjusting brightness of such display systems.

2. Description of the Related Art

Displays are used in various devices, such as cameras, cellular phones, and computers. These displays may be used in various ambient light conditions. Generally speaking, a display in a poorly lit environment is required to have lower brightness than one in a brightly lit environment for it to be comfortably viewed. In other words, different ambient light conditions require brightness adjustments to a display for comfortable viewing. However, most display systems have only manual adjustment function for brightness, which is inconvenient for users of those systems.

### SUMMARY

A display system includes a display panel, a solar battery, an electric current measuring module, a memory module, and a brightness adjusting module. The solar battery is for converting light energy into electric current. The electric current measuring module is for measuring current generated from the solar battery. The memory is for storing a pre-defined associative array of electric current values and their corresponding brightness values. The brightness adjusting module is for retrieving a brightness value from the stored associative array based on the electric current value measured by the electric current measuring unit, and adjusting the brightness of the display accordingly.

Other advantages and novel features of the present invention will be drawn from the following detailed description of at least one preferred embodiment, when considered in conjunction with the accompanying drawing.

### BRIEF DESCRIPTION OF THE DRAWINGS

Many aspects of the present display system and method can be better understood with reference to the accompanying drawing. The components in the drawing are not necessarily drawn to scale, the emphasis instead being placed upon clearly illustrating the principles of the present invention.

The accompanying drawing shows functional blocks of a display system capable of auto-adjusting brightness, according to an exemplary embodiment.

### DETAILED DESCRIPTION OF THE EMBODIMENTS

Preferred embodiments of the present display system and method will now be described in detail below with reference to the drawing.

Referring to the drawing, a display system 100 in accordance with an exemplary embodiment is illustrated. The system 100 comprises a display panel 110, a solar battery 120, an electric current measuring module 130, a memory 140, and a brightness adjusting module 150.

The display panel 110 is for displaying information that the display system 100, by its purpose, is supposed to render on the display panel 110.

The solar battery 120 is configured for converting light energy into electric current, and also functions as a power supply of the display system 100. Generally, the brighter an ambient environment is, the more electric current is generated by and passes through the solar battery 120. Understandably, the number of solar batteries can be more than one. Particularly, the solar battery 120 and the display panel 110 are located on the same side of the display system 100.

The electric current measuring module 130, such as an ammeter, is configured for measuring current generated from the solar battery 120.

The memory 140 is configured for storing a pre-defined associative array of integer values representing the amount of electric current measured from the solar battery 120 under certain lighting condition and their corresponding brightness values desirable for the lightning condition. In this embodiment, in order to reduce the complexity of algorithms used for lookup in the associative array, integer values are used to represent electric current values in the associative array.

The brightness adjusting module 150 is configured for querying/retrieving the associative array stored in the memory 140 to get the corresponding brightness value based on the measured electric current by the electric current measuring module 130. A measured electric current value is first rounded to its nearest integer value, and then used as a key to get the corresponding brightness value from the associative array. The brightness adjusting module 150 uses the retrieved brightness value to adjust the brightness of the display panel 110. The brightness of the display panel 110 can be thus automatically adjusted in real time based on the amount of the electric current generated by the solar battery 120 under ambient lighting conditions.

Table 1 shows an example of a pre-defined associative array, which comprises a collection of integers (representing electric current values) and a collection of the corresponding brightness values that are desirable under certain ambient lighting conditions whereunder the electric current values are generated (after being rounded to integers).

TABLE 1

| | | | | | | | | | | |
|---|---|---|---|---|---|---|---|---|---|---|
| Electric Current Value (mA) | 1 | 2 | 3 | 4 | 5 | 6 | 7 | 8 | 9 | 10 |
| Brightness Value (cd/m²) | 110 | 120 | 130 | 140 | 150 | 160 | 170 | 180 | 190 | 200 |

For example, if the ambient environment is poorly lit, and the actually measured current value is 2.3 mA, which is considered relatively low, the brightness adjusting module 150 rounds the value 2.3 mA to 2 mA, and looks up in the Table 1 for the brightness value corresponding the integer value of the electric current. In this instance, the electric current value 2 mA maps to the brightness value 120 cd/m². The brightness adjusting module 150 then adjusts the brightness of the display panel 110 to 120 cd/m², to make the display panel 110 comfortable to view in the ambient environment.

Now we turn to a method for auto-adjusting brightness of a display system equipped with a solar battery, which is principally illustrated in the preceding exemplary embodiment. The method comprises: measuring electric current generated by a solar battery; rounding the electric current value to its nearest integer value; using the rounded electric current value to query a pre-defined associated array to get the corresponding brightness value; and adjusting the brightness of the display system to the corresponding brightness value.

It is understandable that the above particular embodiments of the present invention are shown and described by way of illustration only. The principles and features of the present invention may be employed in various embodiments without departing from the scope of the present invention as claimed. The above-described embodiments illustrate the scope of the invention but do not restrict the scope of the invention.

What is claimed is:

1. A display system comprising:
a display panel;
a solar battery configured for converting light energy into electric current;
an electric current measuring module configured for measuring current from the solar battery;
a memory configured for storing a pre-defined associative array comprising a collection of current values and a collection of corresponding brightness values; and
a brightness adjusting module configured for querying the associative array to get the corresponding brightness value using the electric current value, and adjusting the brightness of the display panel based on said corresponding brightness value.

2. The display system as claimed in claim 1, wherein the current values in the associative array are integer values, and the brightness adjusting module rounds the measured current value to integer value before querying the associative array.

3. The display system as claimed in claim 1, wherein said solar battery is further configured for providing power to the display panel.

4. A method for adjusting brightness of a display system equipped with a solar battery and a memory, wherein the memory stores a pre-defined associative array containing a collection of electric current values and a collection of corresponding brightness values, the method comprising:
measuring electric current passing through the solar battery;
retrieving a brightness value using the measured electric current; and
adjusting the brightness of the display system based on the retrieved brightness value.

5. The method as claimed in claim 4, wherein the electric current values in the associative array are integers, further comprising rounding the measured electric current value to its nearest integer before retrieving a brightness value.

6. The method as claimed in claim 4, further comprising providing power supply to said display system using said solar battery.
